(19) United States
(12) Patent Application Publication
(10) Pub. No.: US 2026/0309529 A1
(43) Pub. Date: Oct. 8, 2026

(54) GAS METER

(71) Applicant: PIETRO FIORENTINI S.p.A., Arcugnano (VI) (IT)

(72) Inventor: Mario Pietro NARDI, Arcugnano (VI) (IT)

(73) Assignee: PIETRO FIORENTINI S.p.A., Arcugnano (VI) (IT)

(21) Appl. No.: 19/481,894

(22) PCT Filed: Jun. 4, 2024
(86) PCT No.: PCT/IB2024/055440

§ 371 Date: Nov. 6, 2025

(30) Foreign Application Priority Data
Jun. 6, 2023 (IT) 102023000011481

(51) Int. Cl. G01F 15/14; G01F 15/00; G01F 15/12

(52) U.S. Cl. CPC G01F 15/14; G01F 15/005; G01F 15/125

(57) ABSTRACT

A gas meter includes:
an inlet mouth and an outlet mouth for the passage of a gas flow, respectively entering inside the meter and exiting the meter;
a detection module which is housed inside the containment casing and which is configured to detect at least one parameter of the gas entering/passing through the meter itself, the detection module includes a measurement duct for the passage of the gas to be detected;
a plurality of through holes obtained on the side walls of an outlet duct, or on a wall of an outlet structure, housed inside the containment casing and it is fluidly connected upstream with the measurement duct of the detection module and downstream it is connected with the outlet mouth of the meter, the plurality of through holes defining a plurality of passages for the gas towards the outlet mouth without crossing the detection module.

### CROSS-REFERENCE TO RELATED APPLICATIONS

The present application is a § 371 U.S. National Phase of PCT/IB2024/055440, filed Jun. 4, 2024, which claims priority of Italian Patent Application No. 102023000011481, filed Jun. 6, 2023, the entire contents of all of which are incorporated by reference herein as if fully set forth.

### TECHNICAL FIELD

The present invention concerns a gas meter.

In particular, the meter is of the type suitable for measuring one or more quantities relating to a gas that passes through a passage pipe wherein the meter is mounted and, more in detail, it is suitable for measuring at least the flow rate and/or the flow of gas passing through the meter. Preferably, the gas to be measured can be natural gas or other gases produced in a decentralized way, such as biomethane or hydrogen.

In particular, the present invention concerns a gas meter (also called “gas meter”).

Therefore, the invention finds advantageous use in the technical sector of the production and marketing of apparatuses and devices for gas measurement and can advantageously be used both at a domestic and industrial level. Conveniently, the device according to the invention can be used for counting gas consumption in a domestic or industrial system, or for counting gas consumption in general, for example coming out of a container.

### STATE OF THE ART

Nowadays, static gas meters which do not have moving parts are known and widespread.

Such gas meters of known type generally include:
a containment structure that is defined by a box-like body or metal casing,
an inlet and an outlet, defined on the box-like body, for the passage of a gas flow inside the box-like body itself,
a shut-off valve for the gas flow passing through said gas meter,
a module for detecting one or more parameters for determining the gas flow rate,
filtration means for the gas flow.

The detection module includes, within it, one or more sensors—for example ultrasonic or thermo-mass—capable of detecting one or more quantities useful for direct or indirect measurement, or through processing of the detected data, of the gas flow rate.

Industry regulations require the meter to pass resistance tests to contaminants present in the gas entering the meter itself. And it is precisely for this purpose that, inside the meter, filtration means are provided to protect the detection module and the shut-off valve from contaminants present in the gas. In particular, the filtration means are positioned—in the order of crossing of the gas flow—upstream with respect to the detection module which can be mechanically associated with an inlet duct, which is fluidly connected to the inlet mouth, or can be mechanically associated with an outlet duct, which is fluidly connected to the outlet.

Furthermore, conveniently, at the inlet duct and/or—preferably—the outlet duct, a valve can be provided to shut off the gas flow which passes through the duct itself.

Inevitably, the filtration means and the detection module, as well as the changes in direction due to the passages through the ducts provided in the meter, cause a drop/absorption of pressure of the gas that enters and passes through the meter itself and, the sector regulations (for example the EN 14236 standard), require that this gas pressure drop/absorption, in conditions of maximum flow rate, be lower than a predefined limit, for example approximately 2 mbar for meters with a caliber up to G6 and 2.2 mbar after exposure to contaminants (the so-called “dust test” provided for in paragraph 5.7 of the aforementioned EN 14236 standard).

In this context, in order to reduce the fall/absorption of the gas that enters and passes through the meter, it has already been proposed to use an additional tubular duct which is fluidly connected to the outlet in parallel with the duct of the detection module, to thus define a duct for the gas that acts as a by-pass with respect to the passage through the detection module. This solution is not satisfactory as it is constructively complicated and expensive to implement, requiring in particular to create a further passage duct and to connect it mechanically to the exit duct associated with the exit mouth.

Furthermore, if on the one hand the creation of a by-pass passage—which thus defines a passage for the gas towards the outlet which is an alternative to the passage through the detection module—allows to reduce the pressure drop/absorption of the gas at the outlet of the meter, on the other hand the provision of this by-pass passage inevitably reduces the flow rate of gas reaching the detection module. In fact, the gas flow entering the meter is divided, within the meter itself, between the by-pass passage and the detection module. In the event that the gas flow rate reaching the detection module is lower than the minimum flow rate required for activation of the detection module sensor, the latter does not carry out any detection.

In particular, consider that the flow sensor of the detection module has a lower limit of detectable flow rate, which is set at firmware level, and for example can be approximately 3.5 l/h. In more detail, below this limit, the sensor does not activate and therefore returns a value of “0”. Additionally, during normal operation, if the sensor detects flow below the lower limit for a certain number (e.g. 15) of consecutive samples (e.g. with a 2 second sampling period), the sensor turns off and returns “0”.

In essence there are two opposing needs given that on the one hand the increase in the bypass section allows for a reduction in the pressure drop/absorption between the inlet and outlet of the meter, but this comes with the risk of dividing the gas flow so as not to have a sufficient gas flow to cause the activation of the detection module sensor; on the other hand, however, the reduction of the bypass section allows the gas flow to be divided in such a way as to still have a gas flow rate suitable for causing the activation of the detection module sensor, but it comes with the risk of not being sufficient to reduce the pressure drop/absorption between the inlet and outlet of the meter.

It is therefore clear that, in this situation, there is on the one hand the need to reduce the pressure drop of the gas between the inlet and outlet of the meter, but on the other hand this cannot lead to a division of the gas flow between the detection module and the by-pass section such as to have an insufficient gas flow rate to cause the activation of the detection module sensor.

CN217504897U concerns a gas meter wherein, inside the containment casing, between the outlet and the detection module, a ventilation structure is placed which includes, on the walls, a grid surface.

An object of the invention is to propose a gas meter which allows to overcome, at least in part, the drawbacks and limitations of traditional solutions.

Another object of the invention is to propose a gas meter wherein the gas pressure drop between the inlet and outlet of the meter itself is in line with sector regulations, and this without compromising the metrological performance of the meter itself.

Another object of the invention is to propose a gas meter wherein the gas pressure drop between the inlet and outlet of the meter itself is in line with sector regulations, without at the same time altering the precision and reliability of the measurement carried out by the detection module.

Another object of the invention is to propose a gas meter wherein various types of detection modules can be used, even those already available on the market, and this without compromising the metrological performance of the meter itself.

Another object of the invention is to propose a gas meter that is safer with respect to the risks of tampering.

Another object of the invention is to propose a gas meter with performances not inferior to known gas meters.

Another object of the invention is to propose a gas meter that is easy and quick to maintain, as well as inexpensive.

Another object of the invention is to propose a gas meter which can be obtained in a simple, rapid and low-cost manner.

Another object of the invention is to propose a gas meter that is in line with the regulations in force in the sector.

Another object of the invention is to propose a gas meter that allows precise and reliable measurement, even over time, of the gas passing through it.

Another object of the invention is to propose a gas meter that is highly safe and reliable.

Another object of the invention is to propose a gas meter that is an improvement and/or alternative to traditional ones.

Another object of the invention is to propose a gas meter which presents an alternative characterization, both in constructive and functional terms, compared to traditional ones.

### SUMMARY

All the objects mentioned here, considered both individually and in any combination thereof, and others which will result from the following description are achieved, according to the invention, with a gas meter as described below.

### BRIEF DESCRIPTION OF THE FIGURES

The present invention is further clarified below in some of its preferred practical embodiments reported for purely illustrative and non-limiting purposes with reference to the attached drawings, wherein:

FIG. 1 shows a perspective cross-section of the gas meter according to the invention,

FIG. 2 shows a view of the meter in FIG. 1 sectioned according to a vertical plane passing through the center of both mouths of the meter itself,

FIG. 3 shows a view of the meter in FIG. 1 according to section III-III of FIG. 2,

FIG. 4A shows a perspective view (with the internal parts hatched) of the outlet duct provided in the meter of FIG. 1,

FIGS. 4B and 4C show two perspective views of the outlet duct in FIG. 4A,

FIG. 5 shows a perspective view (with the internal parts hatched) of a second embodiment of the outlet duct provided in a meter according to the invention,

FIG. 6 shows a perspective view of a third embodiment of the outlet duct provided in a meter according to the invention, and

FIGS. 7A and 7B show two perspective views of a fourth embodiment of the outlet duct provided in a meter according to the invention,

FIG. 8 shows a perspective cross-section of a further and different embodiment of the gas meter according to the invention,

FIG. 9 shows a perspective view from above of a detail of the meter in FIG. 8,

FIG. 10 shows a plan view of the detail in FIG. 9,

FIG. 11 shows section XI-XI of FIG. 10.

### DETAILED DESCRIPTION OF THE PREFERRED EMBODIMENTS

With reference to the cited figures, the present invention concerns a gas meter which is indicated as a whole with the numeral 10. Conveniently, the gas meter 10 is a gas counter. Preferably, the gas meter 10 is configured to indicate the total volume of gas passed through the pipe section on which it is installed.

The gas meter 10 includes:
a containment casing 11,
an inlet mouth 15 and an outlet mouth 16 for the passage of a gas flow, respectively entering inside the meter 10 and exiting from the meter 10.

Conveniently, the inlet mouth 15 and the outlet mouth 16 are formed on the containment casing 11.

Preferably, the inlet mouth 15 is obtained on an upper wall 12 of the casing 11. Preferably, the outlet mouth 16 is obtained on an upper wall 12 of the casing 11. Conveniently, it is to be understood that the inlet mouth 15 and the outlet mouth 16 can both be made on another same wall other than the upper wall 12. It is to be understood that the inlet mouth 15 and the outlet mouth 16 can each be made on a respective wall of the containment casing 11, different from the wall on which the other mouth is made.

Conveniently, the containment casing 11 is leakproof to prevent the escape of gas towards the outside. Preferably, the containment casing 11 is formed by two or more parts 11′ and 11″ which are joined together in such a way to guarantee the hermeticity of the entire casing. Preferably, the containment casing 11 is made of metal, in particular of sheet metal or die casting.

Inside the containment casing 11 of the meter 10 there is a detection module 19 of one or more gas parameters, in particular for the detection of one or more parameters for determining the flow rate of the gas entering/passing through the meter itself.

Advantageously, inside the containment casing 11 of the meter 10 there can also be housed a shut-off valve (indicated schematically in the figures with the reference number 18) of the gas flow that passes through the meter 10. Preferably, the shut-off valve 18 is a solenoid valve. Conveniently, the shut-off valve 18 can be positioned at the inlet mouth 15 or at the outlet mouth 16.

Conveniently, the gas meter 10 can include, at its inlet port 15, an inlet fitting 23. Preferably, the inlet fitting 23 is fixed (if it is made in a separate piece) and/or integrated (if it is made in a single piece with the corresponding part 11′) to the casing 11 at the inlet mouth 15 of the casing itself. Preferably, in a possible embodiment, the inlet fitting 23 is provided with an externally threaded portion to thus allow its screwing into a corresponding internal thread provided at the inlet mouth 15 of the containment casing 11.

Conveniently, the gas meter 10 can include, at its outlet mouth 16, an outlet fitting 24. Preferably, the outlet fitting 24 is fixed (if it is made in a separate piece) and/or integrated (if it is made in a single piece with the corresponding part 11′) to the casing 11 at the outlet mouth 16 of the casing itself. Preferably, the outlet fitting 24 is provided with an externally threaded portion to thus allow its screwing into a corresponding internal thread provided at the outlet mouth 16 of the containment casing 11.

Conveniently, filtration means 17 for the gas flow are also housed inside the containment casing 11 of the meter 10.

Preferably, the meter 10 includes an inlet duct 25 connected, more preferably sealed, with the inlet mouth 15, to thus define an inlet path for the gas flow inside the containment casing 11.

Preferably, the meter 10 includes a first zone 26 and a second zone 22 which are defined entirely inside the containment casing 11. Conveniently, the flow of gas entering the meter 10 first passes through the first zone 26 and then through the second zone 22 and, therefore, considering the flow of gas inside the meter, the second zone 22 is defined downstream with respect to the first zone 26.

Preferably, the first zone 26 and the second zone 22 are defined inside the containment casing 11 so that:
the first zone 26 is in fluid communication with the inlet mouth 15, preferably via an inlet duct 25,
the second zone 22 is in fluid communication with the detection module 19.

Preferably, the flow of gas from the first zone 26 to the second zone 22 occurs exclusively through at least one passage comprising filtration means 17. In other words, preferably, the first zone 26 and the second zone 22 are fluidly connected to each other only by passing through said filtration means 17.

The inlet of the detection module 19 is in fluid communication with the second zone 22. Preferably, the detection module 19 and/or the shut-off valve 18 are housed inside the second zone 22.

Conveniently, the first zone 26 can be in fluid communication with the inlet mouth 15—and preferably with the inlet fitting 23—via an inlet duct 25 which is housed entirely inside the casing 11. Conveniently, the inlet duct 25 can cross—at least in part—the second zone 22.

Preferably, the first zone 26 is configured so that the gas flow enters inside it only through the inlet duct 25 and from here exits towards the second zone 22 only through at least one passage which is provided with filtration means 17.

Preferably, the inlet duct 25 is configured to be fluidly sealed, preferably via the inlet fitting 23, with a gas inlet pipe (not shown) external to the meter 10. Suitably, the inlet duct 25 is configured to receive and be crossed by all the gas that is destined to enter inside the casing 11.

Advantageously, the inlet duct 25 can be configured to cross the inlet mouth 15 and to fit tightly into the inlet fitting 23. Preferably, the inlet duct 25 crosses the inlet mouth 15 and extends towards an opposite wall, i.e. the bottom wall 13, of the containment casing 11.

In particular, the inlet duct 25 includes an inlet section 74 which fits tightly into the inlet fitting 23. Conveniently, the inlet section 74 is configured to engage in an aspect ratio within the inlet fitting 23. Advantageously, furthermore, a gasket, preferably an O-ring, is mounted on the external walls of the inlet section 74, which is intended to be compressed by the internal walls of the inlet fitting 23 when the inlet section 74 is inserted inside the fitting itself. Conveniently, for this purpose, a seat can be provided on the external walls of the inlet section 74, for example a circumferential groove, and/or a circumferential flange, to keep the gasket in position.

Advantageously, at the inlet section 74, the inlet duct 25 can be provided, below the gasket, with a flange to ensure a block in the event of a possible release of the inlet duct from the inlet fitting 23 and, furthermore, it advantageously acts as a reference for mounting the inlet duct in the inlet fitting 23 to prevent the first from entering too much inside the second.

Preferably, the inlet duct 25 also includes at least one outlet section 75 which is in direct or indirect communication with the first zone 26.

Preferably, the inlet duct 25 has a bottom 76 which is closed and which faces longitudinally the inlet section 74, while at least one outlet section 75 is formed on the side walls of the inlet duct itself.

Conveniently, the inlet duct 25 can comprise an elongated body which is internally hollow to thus allow the gas to pass through. Preferably, the inlet duct 25 is made in a single piece. Conveniently, the inlet duct 25 is made of polymeric material, preferably by molding. Preferably, the inlet duct 25 comprises a substantially tubular body and the gas flow exits from said inlet duct crossing the lateral surface of said substantially tubular body.

Advantageously, therefore, the flow of gas which crosses the inlet duct 25 in a substantially vertical direction from top to bottom is diverted by the bottom 76 of the duct itself towards the outlet section 75 and therefore within the first zone 26. Therefore, the flow of gas which from the first zone 26 then passes into the second zone 22 is forced to pass through the passages comprising said filtration means 17.

Therefore, advantageously, the gas flow that reaches the second zone 22 to then enter the detection module 19 is suitably filtered and cleaned of dust.

As mentioned, inside the containment casing 11 there is a module 19 for detecting one or more parameters, preferably for determining the gas flow rate. Conveniently, the detection module 19 includes a measurement duct 20 for the passage of the gas to be detected. In particular, the measurement duct 20 comprises its inlet opening 20a and its outlet opening 20b.

Preferably, a device for measuring the flow rate of the gas passing through the measurement duct is operationally associated with the measurement duct 20 through which the gas passes. Conveniently, the flow measurement device is of the static type and, in particular, it can be of the ultrasonic or thermo-mass type. Preferably, the sensors of the measuring device are mounted and/or associated with the measuring duct 20 so as to detect a corresponding quantity of the gas passing through said duct.

Advantageously, in a possible embodiment of the invention, the detection module 19 can include an electronic unit (not shown) external to the measurement duct 20. Conveniently, the electronic unit is configured to power and control the sensors of the measurement device, to receive the detection signals emitted by the sensors and to transmit the signals and/or data to an external control unit.

Preferably, the measurement duct 20 is arranged substantially horizontally inside the casing 11.

Conveniently, the detection module 19 can be positioned with the inlet opening 20a of the measurement duct 20 which is in direct fluid communication with the second zone 22.

Conveniently, the meter 10 can include a communication module to transmit the data detected by the measuring device, preferably via wireless, to an electronic control unit located outside the meter.

Conveniently, the meter 10 includes an outlet duct or structure 40 which is housed inside the casing 11 and which is fluidly connected, directly or indirectly, to the outlet mouth 16.

Preferably, the outlet duct 40 extends from the outlet mouth 16 towards an opposite wall 13 of the containment casing 11.

Preferably, the detection module 19 is positioned inside the second zone 22 between the inlet duct 25 and the outlet duct 40.

Preferably, the detection module 19 is in fluid communication with the outlet duct/structure 40. Preferably, the detection module 19 is sealedly connected to the outlet duct/structure 40.

Conveniently, the longitudinal development direction of the measurement duct 20 can be substantially orthogonal to the longitudinal development direction of the inlet duct 25 and/or the outlet duct 40, as described below.

Conveniently, the measurement duct 20 of the detection module 19 is arranged at an angle, preferably in a substantially orthogonal manner, with respect to the outlet duct 40. In particular, the measurement duct 20 of the detection module 19 and the outlet duct 40 are mounted inside the casing so that the respective longitudinal axes are angled to each other, preferably substantially orthogonal to each other.

Preferably, the measurement duct 20 of the detection module 19 is arranged substantially horizontal inside the casing, while the outlet duct 40 is arranged substantially vertical inside the casing itself.

Advantageously, the detection module 19 can be mechanically connected to/mounted on the outlet duct 40, preferably supported by the latter in a suspended condition with respect to the adjacent wall (for example defined by the bottom wall 13) of the casing 11.

Preferably, the outlet duct 40 includes an entry section 43 and a tubular section 44. In particular, the outlet duct 40 is made up of an entry section 43 and a tubular section 44 which is positioned immediately downstream of said section of entrance.

Preferably, the outlet duct 40 is made in a single piece. Conveniently, the outlet duct 40 is made of polymeric material, preferably by molding.

Preferably, the tubular section 44 develops longitudinally and includes one end closed by a bottom 44a while the other end 44b is open to thus allow the passage of the gas towards the outlet mouth 16.

Preferably, the entry section 43 is associated with a side wall of the tubular section 44 at the closed bottom 44a of said tubular section 44. Conveniently, the entry section 43 can be arranged at an angle, preferably orthogonally, with respect to the tubular section 44.

Preferably, the tubular section 44 has a cross section which remains substantially constant (in terms of shape and dimensions) along its entire longitudinal development. Preferably, the tubular section 44 has a substantially circular section.

Preferably, the entry section 43 includes a passage section 45 for the gas of a substantially rectangular shape which is in fluid communication with the inside of the tubular section 44.

Advantageously, the downstream opening of the measurement duct 20 of the detection module 19 can be fluidly connected—preferably directly—with the passage section 45 of the entry section 43 of the outlet duct 40.

Conveniently, the measurement duct 20 can include a downstream terminal section 21 which can be configured to be mechanically engaged with the entry section 43 of the outlet duct 40.

Advantageously, the downstream section 21 of the measurement duct 20 of the detection module 19 can be mechanically connected—preferably directly—with the entry section 43 of the outlet duct 40. Conveniently, the detection module 19 is mechanically associated, preferably directly, to the outlet duct 40. In particular, the downstream section 21 of the measurement duct 20 is mechanically coupled to the entry section 43 of the outlet duct 40.

Preferably, at its external walls, the entry section 43 includes means for mechanical engagement with the downstream terminal section 21 of the measurement duct 20 of the detection module 19. Conveniently, for this purpose, the entry section 43 includes, around the passage section, a collar 47 configured for mechanical coupling with the downstream terminal section 21 of the measurement duct 20 of the detection module 19.

Preferably, the passage section 45 of the entry section 43 has a shape and dimensions substantially corresponding to those of the passage section of the measurement duct 20 of the detection module 19.

The meter 10 according to the invention includes a plurality of through holes 50 which are obtained on the side walls of a duct—preferably the outlet duct 40—which is housed inside the containment casing 11 and is fluidly connected, preferably sealed, upstream with the measurement duct 20 of the detection module 19 and downstream it is connected, preferably sealed, with the outlet mouth 16 of the meter 10, to thus define a plurality of gas passages towards the outlet mouth 16 without crossing the detection module 19.

Conveniently, therefore, the through holes 50 are made on a section of a duct—preferably on the outlet duct 40—which is downstream (considering the gas flow inside the meter 10) with respect to the detection module 19.

Preferably, the outlet duct 40 wherein the through holes 50 are obtained is housed in the second zone 22 and the through holes 50 define a plurality of gas passages from said second zone 22 towards the outlet mouth 16 bypassing the detection module 19.

In particular, the through holes 50 put the second zone 22 in fluid communication with a section of the duct which is downstream (considering the flow of gas inside the meter 10) with respect to the detection module 19. In essence, the through holes 50 define by-pass passages for the gas towards the outlet of the meter 10 since they by-pass the main passage through the measurement duct 20 of the detection module 19.

Conveniently, the plurality of through holes 50 can comprise at least two holes and, preferably, comprise much more than two holes.

Preferably, the through holes 50 are obtained on the outlet duct 40 which is fluidly connected in a sealed manner with the outlet opening 20b of the measurement duct 20 of the detection module 19 and which is fluidly connected in a sealed manner (directly or indirectly) with the outlet mouth 16.

Conveniently, in a possible embodiment, the sum of the areas of the passage sections of the through holes 50 can be equal to or less than the area of the passage section of the measurement duct 20 of the detection module 19. More preferably, the sum of the areas of the passage sections of the through holes 50 can be equal to or less than 15%—preferably it is equal to or less than 10%—of the area of the passage section of the measurement duct 20 of the detection module 19. For example, thirty-two through holes 50 can be provided, each of these having a diameter of 1 mm.

Conveniently, in another possible embodiment not shown here, the through holes 50 are configured so that the sum of the areas of the passage sections of the through holes 50 is greater than the area of the passage section of the measuring duct 20 of the detection module 19.

Conveniently, the through holes 50 are obtained on the tubular section 44 of the outlet duct 40 and, in particular, on a section of the lateral walls of said section.

Preferably, the through holes 50 (and in particular the axes that pass through said holes) develop radially with respect to the center of the circular cross section of the tubular section 44 of the outlet duct 40.

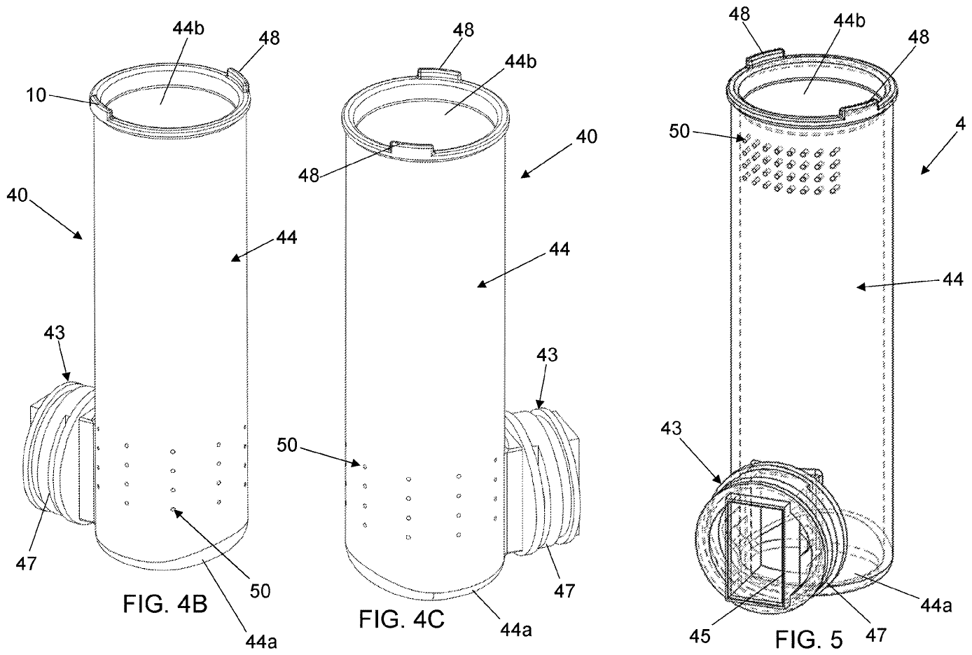

Conveniently, in some possible embodiments (see FIGS. 4A-4C, 6, 7A and 7B), the through holes 50 can be obtained on an area of the side walls of the tubular section 44 of the outlet duct 40 which is defined at the entry section 43 and/or of the closed bottom 44a of the tubular section 44.

Conveniently, in a possible embodiment (see FIG. 5), the through holes 50 can be obtained on an area of the side walls of the tubular section 44 of the outlet duct 40 which is defined at the outlet end 44b of said tubular section.

Conveniently, in a possible embodiment (see FIG. 5), the through holes 50 can be obtained on an area of the side walls of the tubular section 44 of the outlet duct 40 which faces towards the inside or the center of the casing 11 and, preferably, which is turned towards the inlet duct 45.

Conveniently, in a possible embodiment, the through holes 50 can be obtained on at least one area of the side walls of the tubular section 44 of the outlet duct 40 which faces the walls of the casing 11.

Conveniently, in some possible embodiments, the through holes 50 can be obtained in an area that affects the entire or most of the circumferential development of the lateral walls of the tubular section 44 of the outlet duct 40.

Conveniently, in some possible embodiments (see FIGS. 4A-4C, 7A and 7B), the through holes 50 can be obtained in an area that affects the entire or most of the circumferential development that the tubular section presents at the entry section 43 and/or of the closed bottom 44a of said tubular section 44.

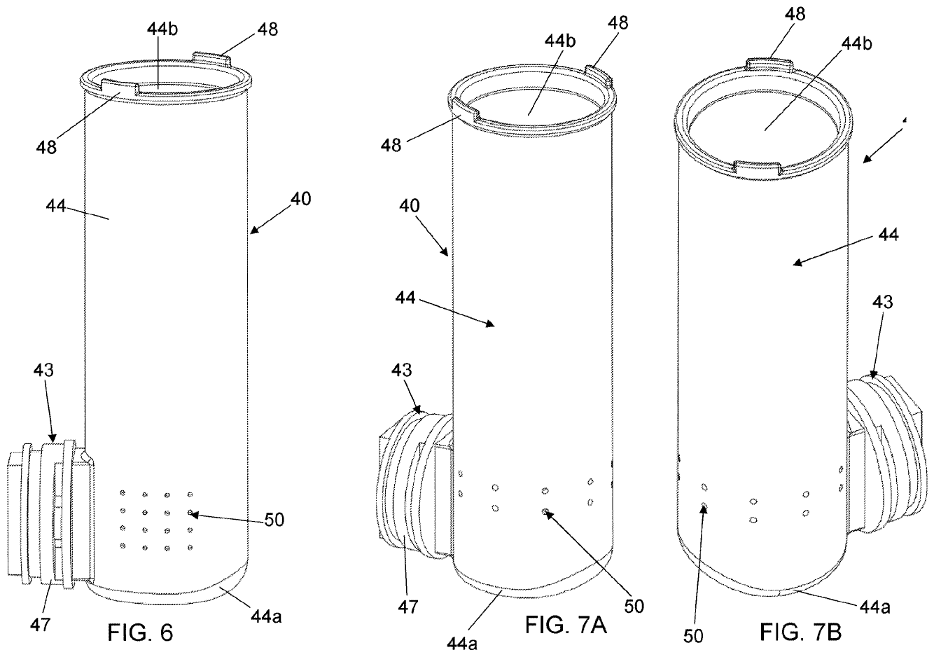

Conveniently, in some possible embodiments, the through holes 50 can be obtained on an area defined by a circumferential arc of the tubular section (see FIG. 5 or FIG. 6), and wherein the circumferential arc has an angle at center less than 180°, preferably less than about 90°.

Conveniently, in some possible embodiments, the through holes 50 can be obtained on two areas of the tubular section positioned on the sides of the entry section 43.

Preferably, the through holes 50 are equally spaced from each other.

Preferably, the through holes 50 are arranged in a regular manner.

Preferably, the through holes 50 are aligned along two mutually perpendicular directions.

Preferably, the through holes 50 have a circular or square passage section.

Preferably, the through holes 50 have a passage section with a diameter/side of approximately 0.5-1.5 mm. Preferably, the through holes 50 have a passage section with a diameter/side of approximately 1.2 mm. Preferably, the through holes 50 have a passage section with a diameter/side equal to or less than approximately 1 mm.

Preferably, the through holes 50 do not have an elongated development in one direction with respect to the other.

Advantageously, by increasing the number of through holes 50 and decreasing the area of the section of said holes, the precision of the measurement carried out by the detection module 19 is increased, in particular decreasing the percentage error in terms of flow rate detected by the detection module itself.

Advantageously, as mentioned, inside the containment casing 11 there can be provided a shut-off valve (which is indicated schematically in the figures with the reference number 18) of the gas flow through the structure of the gas meter 10; conveniently, this shut-off valve 18 has an inlet opening 18a and an outlet opening 18b.

Preferably, the shut-off valve 18 is mounted at the outlet duct 40. Preferably, the shut-off valve 18 is positioned between the outlet duct 40 and the outlet mouth 16 and, suitably, the outlet duct 40 can be fluidly and mechanically connected to the outlet mouth 16 through the shut-off valve 18.

In a possible embodiment not shown, the shut-off valve 18 is not present or could be mounted upstream of the inlet duct 25.

Advantageously, therefore, the detection module 19 and the outlet duct 40—on which the shut-off valve 18 is preferably mounted—define a group which is fluidly connected with the second zone 22 defined inside the casing 11 both through the inlet opening of the detection module 19 and through the through holes 50 obtained on the outlet duct 40, and at the outlet said group is fluidly connected with an outlet pipe to the meter 10.

Preferably, the outlet end 44b of the tubular section 44 of the outlet duct 40 is sealedly connected to the outlet mouth 16.

Preferably, the outlet duct 40 is connected in a sealed manner with the outlet mouth 16 through the outlet fitting 24 and/or through the supporting body of the solenoid valve 18.

Conveniently, at the outlet end 44b of the tubular section 44 of the outlet duct 40, means can be provided for mechanical engagement with the outlet fitting 24 or with the support body of the valve 18. Conveniently, these means for mechanical engagement can be configured to operate by hooking, aspect ratio, interlocking, snap engagement or the like and, for example, can include two elastically compliant fins 48.

As mentioned, at the passage between the first zone 26 (which is in fluid communication with the inlet duct 25) and the second zone 22 (which is in fluid communication with the inlet of the detection module 19) filtration means 17 are provided.

Preferably, the filtration means 17 provided at said at least one passage between the first zone 26 and the second zone 22 comprise a filtering element 90 which is made of a different material compared to that with which the separation element 82 is made.

Conveniently, the filtering element 90 defines a substantially flat, or at most slightly curved, wall/filtering partition between said first zone 26 and said second zone 22.

Conveniently, the filtering element 90 is a filter mat. Conveniently, the filtering element 90 is shaped like a filtering mat. Conveniently, the filtering element is not of the pocket type, and in particular it is not shaped like a sack, envelope or pouch with an open end.

Preferably, the filtering element 90 has fiber layer density that increases from the inlet surface towards the outlet surface.

Preferably, the filtering element 90 has a thickness S of approximately 5-25 mm. Preferably, the filtering element 90 has the filtration class G2, G3 or G4 according to the classification of the CEN EN 779 standard.

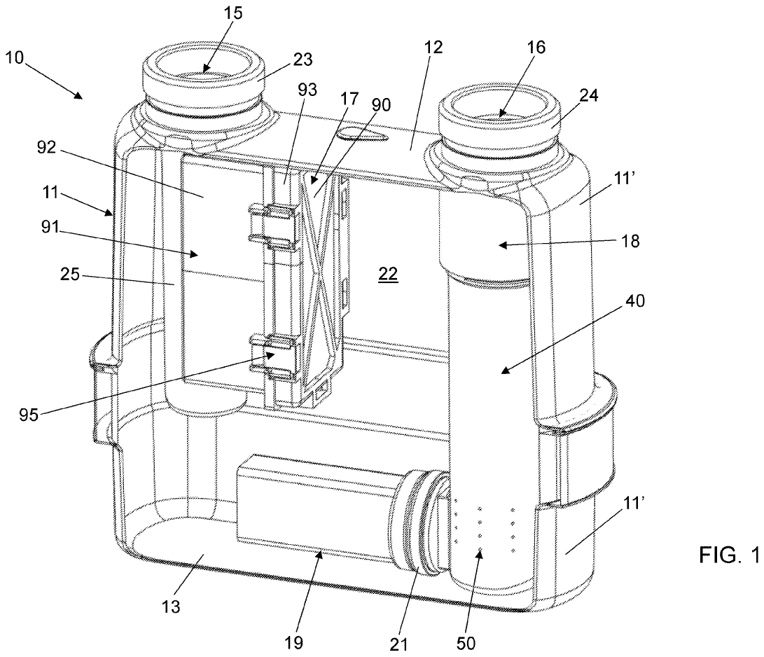

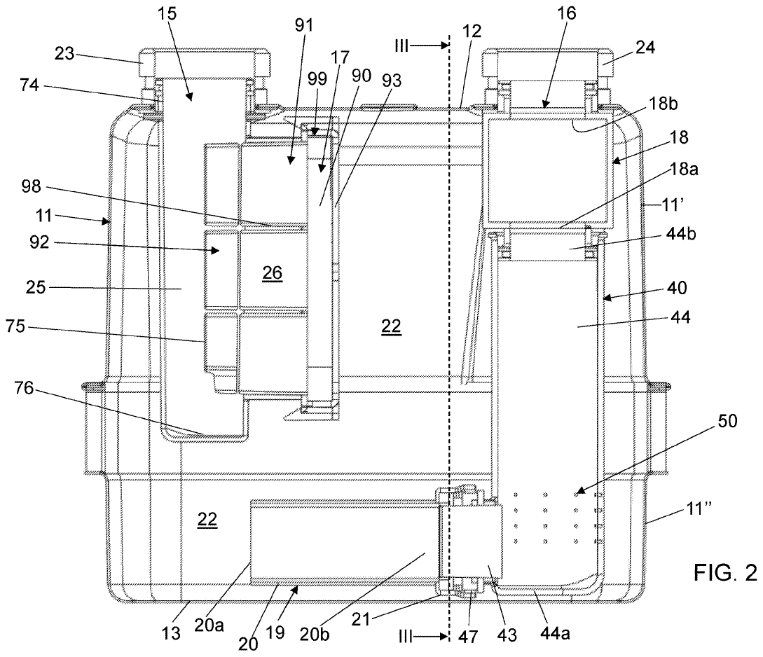

Conveniently, in a preferred possible embodiment represented in FIGS. 1 and 2, the meter 10 comprises a structure 91 which delimits said first zone 26 internally while said second zone 22 is defined outside said structure 91. Said at least one filtering element 90 is mounted on said separation structure 91. Preferably, the filtration means 17 are mounted on the structure 91 which is mounted, integrated and/or supported by the inlet duct 25 so that the inside of said structure is in direct fluid communication with the inside of the inlet duct 25. In particular, as mentioned, the first zone 26 is defined inside a structure 91, preferably box-like, which is mounted on or is supported in a hanging condition by said inlet duct 25, preferably at the central portion of the inlet duct 25. Conveniently, the first zone 26 defined inside the structure 91 is in direct fluid communication with the inlet duct 25 and is in fluid communication with the second zone 22 defined inside the casing 11, only by passing through the filtering element 90 which is mounted on the structure 91, preferably inside the latter.

Conveniently, therefore, the assembly formed by the inlet duct 25 and the structure 91 with the filtering element 90 can thus define a filtration device 99.

Preferably, the structure 91 includes a box-like body 92 which is fixed or made in a single body with the inlet duct 25, preferably at the central portion of said inlet duct 25. Conveniently, in this case, the end of the inlet duct 25 which is opposite to the entrance one has a blind/closed bottom. Furthermore, the structure includes a frame 93 provided with through openings, entirely covered by the filtering element 90, and with coupling means 95, preferably snap-on, to the box-like body 92.

Conveniently, the inside of the box-like body 92 is in fluid communication with the inlet duct 25, is closed laterally and is open only at one of its faces which is then plugged by the filtering element 90 supported by the frame 93 which is mechanically associated to the box-like body 92 by means of the coupling means 95.

Preferably, the filtering element 90 is mounted on the frame 93 and is held by the latter so as to be kept resting on internal baffles 98 of the protruding body 92.

Conveniently, in this embodiment, the frame 93 on which the filtering element 90 is mounted substantially acts as a separation element between the first zone 26 (which is defined inside the separation structure 91 and in fluid communication with the duct entrance) and the second zone 22 (which is in fluid communication with the entrance of the detection module 19 and includes the environment which is external to the structure 91 and which is delimited by the internal walls of the casing 11).

Conveniently, the first zone 26 provided with the filtering element 90 is associated with the inlet duct 25 above the bottom 76 of the duct itself, to thus force the gas flow to rise, at least in part, in countercurrent. Preferably, for this purpose, the protruding body 92 is connected to the inlet duct 25 at a central portion of the latter.

Conveniently, the filtering element 90 is arranged substantially parallel to the direction of longitudinal development of the inlet duct 25 and, preferably, is perpendicular to the bottom wall 13 of the casing 11.

Advantageously, according to the invention, the filtering element 90 is removably mounted on the frame 93, thus allowing its removal and possible reuse after appropriate cleaning.

Conveniently, in the various embodiments, the filtering element 90 is made from a different material compared to the more rigid polymeric materials with which the mounting elements (i.e. the frame 93 and/or the box-like body 92) which support it are made.

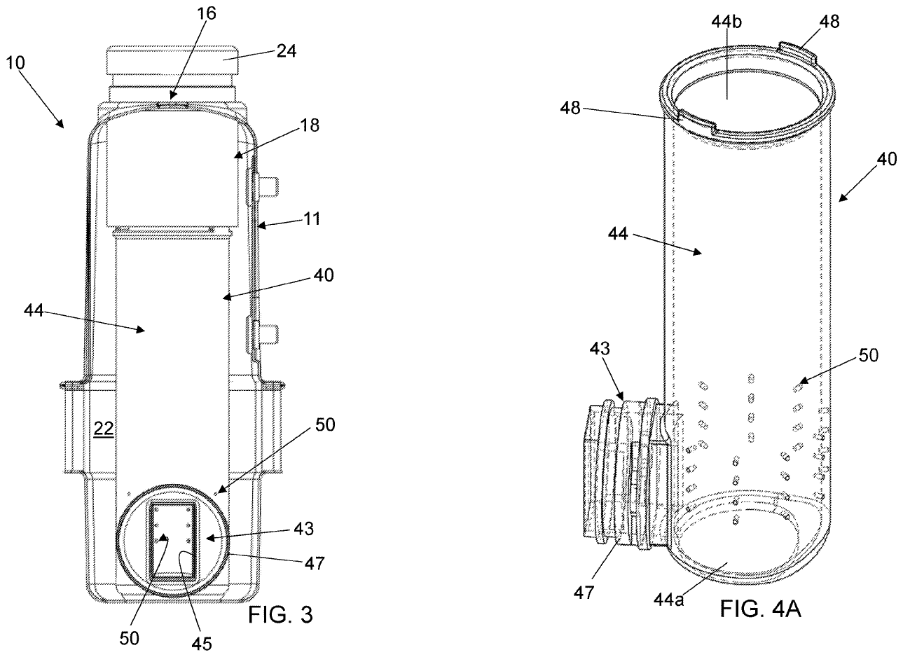

Preferably, in a possible embodiment (see FIG. 1-7), the direction of longitudinal development of the measurement duct 20 of the detection module 19 is angled, more preferably it is substantially perpendicular, to the direction that perpendicularly crosses the section of passage of the outlet mouth 16.

Preferably, in a possible embodiment (see FIG. 1-7), the direction of crossing of the through holes 50 is angled—more preferably it is substantially perpendicular—with respect to the direction that perpendicularly crosses the passage section of the outlet mouth 16.

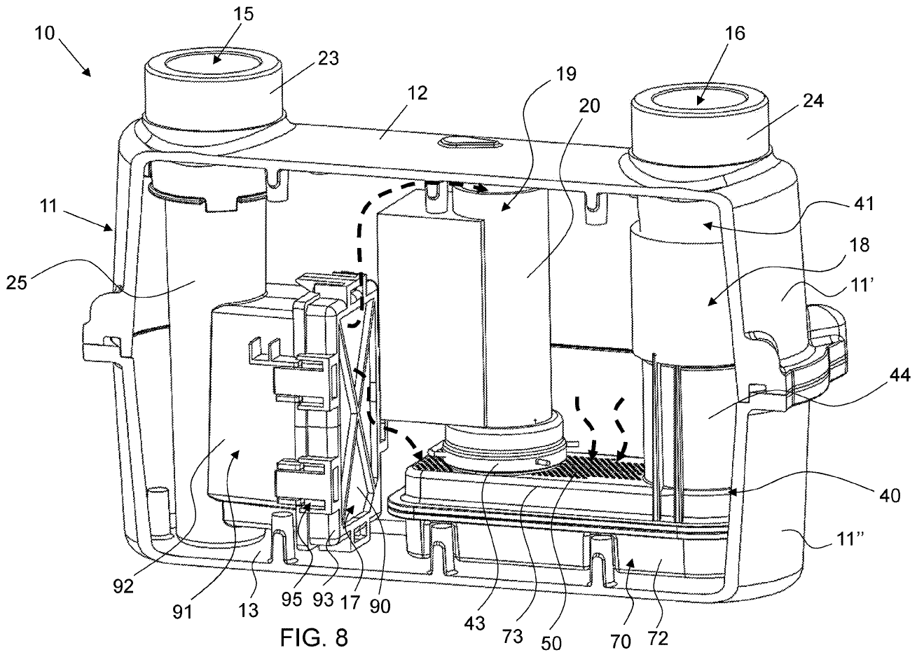

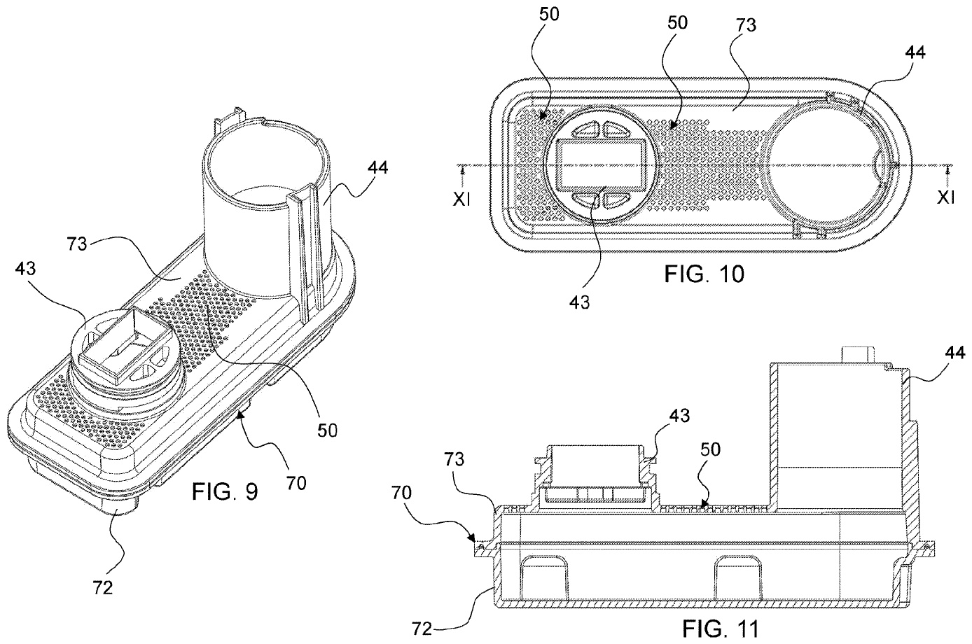

Preferably, in a possible embodiment (see FIG. 8-11), the direction of longitudinal development of the measurement duct 20 of the detection module 19 is substantially parallel and flanked (i.e. not aligned) with the direction that perpendicularly crosses the passage section of the outlet mouth 16.

Preferably, in a possible embodiment (see FIG. 8-11), the direction of crossing of the through holes 50 is substantially parallel to the direction that perpendicularly crosses the passage section of the outlet mouth 16.

In a further embodiment of the meter 10 (see FIG. 8-11), the outlet duct 40—or in any case the outlet structure which is fluidly connected upstream, preferably sealed, with the detection module 19 and downstream is fluidly connected, preferably sealed, with the outlet mouth 16—includes means 70 configured for the deviation of the gas flow exiting the measurement duct 20 of the detection module 19 towards a tubular section 44 of said outlet duct/structure 40.

In a further embodiment of the meter 10 (see FIG. 8-11), the outlet duct 40—or in any case the outlet structure which is fluidly connected upstream, preferably sealed, with the detection module 19 and downstream is fluidly connected, preferably sealed, with the outlet mouth 16—includes:
a longitudinally extending tubular section 44 which at one end is fluidly connected to the outlet mouth 16, and also
means 70 configured for the deviation of the gas flow exiting the measurement duct 20 of the detection module 19 towards the other end of the tubular section 44.

The means for diverting the flow 70 are fluidly connected directly to the downstream opening of the measurement duct 20 of the detection module 19 and are also fluidly connected to a tubular section 44 which in turn is fluidly connected to the outlet mouth 16.

The means for diverting the flow 70 are configured to cause a “U” bend in the flow of gas exiting the detection module 19 to make it enter a tubular section 44 which is fluidly connected to the outlet mouth 16.

Conveniently, the measurement duct 20 of the detection module 19 and the tubular section 44 of the outlet duct 40 are side by side and parallel to each other. Conveniently, the tubular section 44 and the measurement duct 20 are associated with the means for diverting the flow 70 so that the respective directions of longitudinal development are parallel and spaced apart from each other.

Conveniently, the means for diverting the flow 70 of the outlet duct/structure 40 are angled, preferably orthogonal, both to the tubular section 44 of the same outlet duct/structure 40 and to the measurement duct 20 of the detection module 19.

Inside the containment casing 11 there are means 70 configured for the deviation—preferably by an angle of 90°-180° and, even more preferably, by an angle of approximately 180°—of the gas flow exiting from the outlet opening of the measurement duct 20 of the detection module 19 towards the tubular section 44 of the outlet duct 40.

Advantageously, the detection module 19 is positioned, as mentioned above, in the middle between the tubular section 44 of the outlet duct 40 and the inlet duct 25, flanked both by the tubular section 44 of the outlet duct 40 and by the inlet duct 25. In this intermediate position, and thanks to the means 70 for diverting the gas flow exiting from the outlet opening of the detection module 19 towards the inlet opening of the tubular section 44 of the outlet duct 40, the detection module 19 is substantially unreachable from any attempt of tampering which is carried out either through the outlet mouth 16, or possibly through the inlet mouth 15 of the containment casing 11. In fact, the presence on one side of the inlet duct 25, on the other side of the shut-off valve 18 and of the flow diversion means 70, ensures that the detection module 19 is placed substantially at the center of a labyrinthine path that cannot be followed with today's known break-in tools.

Preferably, the tubular section 44 is fixed or is made in a single piece with the means for diverting the flow 70.

Conveniently, in a possible embodiment such as that illustrated in FIGS. 8-11, said plurality of through holes 50 is obtained on the means for diverting the flow 70.

Preferably, the direction of crossing of the through holes 50—which define passages for the gas towards the outlet mouth 16 without crossing the detection module 19 (i.e. bypassing said module)—is parallel to the direction of longitudinal development of the measurement duct 20 of the detection module 19.

Preferably, in this embodiment, the tubular section 44 of the outlet duct/structure 40 is completely free or in any case is substantially free of through holes 50.

Preferably, the means for diverting the flow 70 comprise a tank 72 closed with a lid 73 and configured to define a “U” curvature to the gas flow exiting the measurement duct 20 of the detection module 19 to make it enter the tubular section 44 of the outlet duct/structure 40.

Advantageously, the tank 72 also defines a tank for collecting any dust that has passed through the detection module 19 and which is thus deposited on the bottom of the tank 72.

Conveniently, the tank 72 can rest on the internal face of the bottom wall 13 of the casing 11.

More preferably, the measurement duct 20 of the detection module 19 is fixed or sealingly engages on the lid 73 and also the tubular section 44 of the outlet duct/structure 40 is fixed (or sealingly engages) on the lid 73.

More preferably, the plurality of through holes 50—which define a plurality of passages for the gas towards the outlet mouth 16 without crossing the detection module 19—is obtained on the lid 73. More in detail, in a possible embodiment such as the one illustrated in FIGS. 8-11, the lid 73 of the tank 72 constitutes the side wall of the outlet duct/structure 40 on which the plurality of through holes 50 defining the passages are obtained for the gas towards the outlet mouth 16 without passing through the detection module 19.

Preferably, the tank 72 is made of a single piece of rigid plastic material. Preferably, the edges of the tank 72 are sealed, for example by thermal welding, or with other similar and equivalent seal joining methods, to the lid 73.

Advantageously, the detection module 19, the means for diverting the flow 70 including the tank 72 closed by the lid 73 and the tubular section 44 define a gas-tight assembly which at the inlet is fluidly connected with the second zone 22 defined inside the casing 11 and at the outlet it is fluidly connected to the outlet mouth 16 of the meter 10.

Preferably, the outlet duct 40 can include a terminal section 41 which is sealedly connected to the outlet mouth 16. Conveniently, the terminal section 41 of the outlet duct 40 is configured to engage in an aspect ratio within the outlet fitting 24.

In more detail, the means for diverting the flow 70—and in particular the lid 73 of said means 70—can comprise:
an entry section 43—preferably defined by a junction collar—for connection with the outlet opening of the measurement duct 20 of the detection module 19, and
the tubular section 44 for the connection of the shut-off valve 18 and/or for the connection with a terminal section 41 fluidly connected to the outlet mouth 16.

Preferably, the holes 50 can be made on the lid 73 around the entry section 43 and/or in the area between the entry section 43 and the tubular section 44.

Conveniently, in this embodiment, both the junction collar of the entry section 43 and the tubular section 44 are open and in fluid communication with the tank 72. Conveniently, in this embodiment, the entry section 43 and the tubular 44 are parallel and placed side by side with each other.

Conveniently, the directions of longitudinal development of the measurement duct 20 and of the tubular section 44 are substantially parallel to each other and also to the direction of longitudinal development of the inlet duct 25. Preferably, the detection module 19 is positioned with the inlet opening which is in direct fluid communication with the second zone 22 and which is located near the upper wall 12 of the containment casing 11.

Advantageously, the means for diverting the flow 70 of the outlet duct/structure 40 can be easily made in different configurations so that the meter 10 falls into different regulatory classes without modifying other components. In other words, the means for diverting the flow 70 of the outlet duct/structure 40 allow the meter 10 according to the invention to be adapted to different classes in a simple and economical way, for example by modifying the number of through holes 50. In practice it has been observed how the invention achieves the intended task and objectives.

In particular, the configuration of the filtering section (which is arranged parallel to the inlet duct) and the horizontal arrangement of the measurement duct of the detection module allow to reduce the changes in direction of the gas flow inside the meter, reducing as well as the gas pressure drops between the inlet and outlet of the meter itself.

The presence of a plurality of by-pass holes positioned downstream of the detection module allows reducing the gas pressure drops between the inlet and outlet of the meter itself, but this is achieved without affecting the metrological performance of the meter. In fact, the gas flow entering the meter is appropriately divided between the detection module and the plurality of by-pass holes so as not to influence the correct start-up of the sensor of the detection module. In particular, the flow of gas entering the meter is divided between the detection module and the plurality of by-pass holes so that the sensor of the detection module receives a sufficient flow rate to allow its activation (for example greater than 3.5 l/h).

The meter according to the invention is particularly advantageous as it allows to have a meter suitable for managing a greater flow rate (particularly in terms of minimum flow rate), and therefore it can be of a higher class, while at the same time respecting the characteristics required by the regulations sector in terms of pressure absorption/drop between inlet/outlet of the meter itself (i.e. less than approximately 2 mbar, more preferably less than approximately 1.25 mbar, with adequate safety margin), and this is achieved without compromising the metrological performance in terms of precision of flow rate detection and above all in terms of minimum activation flow rate of the detection module.

The meter according to the invention is particularly advantageous as it allows the detection of a starting flow rate which is lower than that required by industry regulations for that specific class of meter.

The meter according to the invention is particularly advantageous as it allows the same detection module to be used for meters of different classes; in particular, for example, a detection module normally suitable and designed for a meter of the G4 class can also be used in a meter according to the invention of the G6 class. This allows for significant cost savings for the construction of the meter, as well as allowing the use of gas mixtures which also include hydrogen and which generally require higher flow rates in order to obtain the same energy that is provided by a mixture of methane only (since the hydrogen has a calorific value approximately three times lower than that of methane).

The present invention has been illustrated and described in one of its preferred embodiments, but it is understood that executive variations may be made to it in practice, without however departing from the scope of protection of the present patent for industrial invention. The invention thus conceived is susceptible to numerous modifications and variations, all of which fall within the scope of the inventive concept; furthermore, all details may be replaced by other technically equivalent elements. In practice, the components and materials used, provided they are compatible with the specific use, as well as the contingent dimensions and shapes, may be any depending on the needs and the state of the art. Where the features and techniques mentioned in any claim are followed by reference marks, such reference marks are intended to be affixed for the sole purpose of increasing the intelligibility of the claims and consequently such reference marks have no limiting effect on the interpretation of each element identified by way of example by such reference marks.

1. Gas meter comprising:
a containment casing,
an inlet mouth and an outlet mouth for the passage of a gas flow, respectively entering inside the meter and exiting the meter,
a detection module which is housed inside the containment casing and which is configured to detect at least one parameter of the gas entering/passing through the meter itself, said detection module comprising a measurement duct for the passage of the gas to be detected,
a plurality of through holes which are obtained on side walls of an outlet duct, or on a wall of an outlet structure, which is housed inside said containment casing and is fluidly connected, upstream with the measurement duct of the detection module and is connected downstream with the outlet mouth of the meter, said plurality of through holes defining a plurality of passages for the gas towards the outlet mouth without crossing the detection module.

2. The gas meter according to claim 1, wherein said through holes are configured so that the sum of the areas of the passage sections of the through holes is equal to or less than the area of the passage section of the measurement duct of the detection module.

3. (canceled)

4. The gas meter according to claim 1, characterized in that said through holes are configured so that the sum of the areas of the passage sections of the through holes is greater than the area of the passage section of the measurement duct of the detection module.

5. The gas meter according to claim 1, further comprising a first zone and a second zone, both defined inside the casing, said first zone being in fluid communication with the inlet mouth, said second zone being in fluid communication with the input of the detection module, said outlet duct/structure, wherein said through holes are obtained, being housed in said second zone and said through holes defining a plurality of gas passages from said second zone towards the outlet mouth bypassing the detection module.

6. The gas meter according to claim 5, wherein the fluid connection between said first zone and said second zone occurs exclusively through at least one passage comprising filtering means.

7.-10. (canceled)

11. The gas meter according to claim 1, wherein a longitudinal development direction of the measurement duct is angled with respect to the direction of development of the outlet duct on which said through holes are obtained.

12. The gas meter according to claim 1, wherein said detection module is mechanically connected to said outlet duct, supported by said outlet duct in a suspended condition with respect to the adjacent casing wall.

13. The gas meter according to claim 1, wherein said outlet duct includes an entry section and a tubular section, said entry section being associated with a side wall of the tubular section at a closed bottom of said tubular section, said entry section is arranged at an angle with respect to the tubular section, said through holes being obtained on an area of the side walls of the tubular section of said outlet duct, said entry section being configured to be mechanically associated with a downstream terminal section of the measurement duct.

14. The gas meter according to claim 13, wherein said through holes are obtained on an area of the side walls of the tubular section of said outlet duct which is defined at a closed bottom of said tubular section.

15. The gas meter according to claim 13, wherein said through holes are obtained on an area of the side walls of the tubular section of said outlet duct which is defined at the outlet end, which is opposite to the end provided with said closed bottom, of said tubular section.

16. (canceled)

17. The gas meter according to claim 13, wherein the through holes are obtained in an area which includes the entire or most of the circumferential development of the lateral walls of the tubular section of the outlet duct.

18.-19. (canceled)

20. The gas meter according to one or more of claim 1, wherein the direction of longitudinal development of the detection module is substantially parallel to the direction of longitudinal development of the tubular section of the outlet duct.

21. (canceled)

22. The gas meter according to claim 1, wherein the crossing direction of the through holes is angled with respect to the direction that perpendicularly crosses the passage section of the outlet mouth.

23. (canceled)

24. The gas meter according to claim 1, wherein the crossing direction of the through holes is substantially parallel to the direction that perpendicularly crosses the passage section of the outlet mouth.

25. The gas meter according to claim 1, wherein the crossing direction of the through holes is substantially parallel to the direction of longitudinal development of the measurement duct of the detection module.

26. The gas meter according to claim 1, wherein said outlet duct which is fluidly connected upstream with the detection module and downstream is fluidly connected with the outlet mouth includes means for diverting the gas flow exiting the measurement duct of the detection module towards a tubular section of said outlet duct/structure.

27. The gas meter according to claim 26, wherein said means for diverting the flow are configured to cause a “U” curvature to the flow of gas exiting the detection module to make it enter a tubular section which is fluidly connected to the outlet mouth.

28. The gas meter according to claim 26, wherein said plurality of through holes is obtained on the means for diverting the flow.

29. The gas meter according to claim 26, wherein:
the means for diverting the flow include a tank closed with a lid and configured to define a substantially “U” shaped curvature to the gas flow exiting the measurement duct of the detection module to make the gas flow enter a tubular section of the outlet duct/structure, and
the plurality of said through holes, which define a plurality of passages for the gas towards the outlet mouth without crossing the detection module is obtained on the lid.

30. The gas meter according to claim 29, wherein the lid includes:
an entry section for connection with the outlet opening of the measurement duct of the detection module,
a tubular section for the connection of at least one of the shut-off valve or a terminal section fluidly connected to the outlet mouth,
said plurality of through holes which define a plurality of passages for the gas towards the outlet mouth without crossing the detection module.

31.-32. (canceled)
